(19) United States
(12) Patent Application Publication
(10) Pub. No.: US 2023/0373826 A1
(43) Pub. Date: Nov. 23, 2023

(54) APPARATUS AND METHOD FOR PRODUCING PURE WATER

(71) Applicant: ORGANO CORPORATION, Tokyo (JP)

(72) Inventors: Hironori YUI, Tokyo (JP); Yusuke TAKAHASHI, Tokyo (JP); Kazushige TAKAHASHI, Tokyo (JP); Naonori MOMOTANI, Tokyo (JP)

(73) Assignee: ORGANO CORPORATION, Tokyo (JP)

(21) Appl. No.: 18/018,291

(22) PCT Filed: Jul. 16, 2021
(86) PCT No.: PCT/JP2021/026866

§ 371 Date: Jan. 27, 2023

(30) Foreign Application Priority Data
Aug. 6, 2020 (JP) 2020-133742

(51) Int. Cl. C02F 1/76; C02F 1/32; C02F 9/00

(52) U.S. Cl. CPC C02F 1/76; C02F 1/32; C02F 9/00; C02F 2003/003

(57) ABSTRACT

An apparatus for producing pure water has: biological treatment means for biological treatment of water to be treated that contains an organic material; means for adding hypohalogous acid that is positioned downstream of biological treatment means and that adds hypohalogous acid to the water to be treated after the biological treatment is carried out; and ultraviolet ray radiating apparatus that is positioned downstream of means for adding hypohalogous acid and that radiates ultraviolet rays to the water to be treated to which the hypohalogous acid has been added.

### FIELD OF THE INVENTION

The present application is based on, and claims priority from, JP2020-133742 filed on Aug. 6, 2020, the disclosure of which is incorporated by reference herein in its entirety.

The present invention relates to an apparatus and a method for producing pure water.

### BACKGROUND OF THE INVENTION

Conventionally, pure water such as ultrapure water from which organic materials, ion components, fine particles, bacteria, and the like are substantially removed is used for applications such as washing water in the manufacturing process of semiconductor devices and liquid crystal display devices. A large amount of pure water is used particularly in the washing process for manufacturing electronic components that include semiconductor devices, and requirements for the water quality have been raised year by year. The total organic carbon (TOC), which is one of monitoring items for the management of water quality of pure water that is used, for example, in the washing process for manufacturing electronic components, must be limited to an extremely low level such that organic materials that are contained in the pure water are prevented from carbonizing in a subsequent heat treatment process and thereby causing poor insulation.

For this reason, persistent organic materials such as urea must also be removed with high efficiency. JP2011-230093 discloses a method that uses a biological treatment in order to remove urea from water to be treated. A biological treatment utilizes microbes, and because the activity of the microbes may be affected by the water quality of the water to be treated, the efficiency of the biological treatment may be lowered. As a result, an ammoniacal nitrogen source is added to the water to be treated before the biological treatment in order to activate the microbes.

### SUMMARY OF THE INVENTION

Raw water that is treated by an apparatus for producing pure water originates from a variety of water sources, such as public water, underground water, industrial water, and water collected from factories, and the concentration of urea greatly varies in the range from several μg/L to several hundred μg/L. If the concentration of urea is kept high, then the activity of microbes is lowered. Thus, when the concentration of urea increases, urea may remain. Adding an ammoniacal nitrogen source is effective for activating microbes, as disclosed in JP2011-230093, but no measure is disclosed in the method of JP2011-230093 for removing persistent organic materials such as urea that remain in the water to be treated after the biological treatment process.

The present invention aims at providing an apparatus for producing pure water that can remove persistent organic materials such as urea in an effective and stable manner.

An apparatus for producing pure water of the present invention comprises:
a biological treatment means for biological treatment of water to be treated that contains an organic material;
means for adding hypohalogous acid that is positioned downstream of the biological treatment means and that adds hypohalogous acid to the water to be treated after the biological treatment is carried out; and
an ultraviolet ray radiating apparatus that is positioned downstream of the means for adding hypohalogous acid and that radiates ultraviolet rays to the water to be treated to which the hypohalogous acid has been added.

According to the present invention, it is possible to provide an apparatus for producing pure water that can remove persistent organic materials such as urea in an effective and stable manner.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic view of the arrangement of an apparatus for producing pure water according to a first embodiment of the present invention;

FIG. 2 is a schematic view of the arrangement of an apparatus for producing pure water according to a second embodiment of the present invention;

FIG. 3 is a schematic view of the arrangement of an apparatus for producing pure water according to a third embodiment of the present invention;

FIG. 4 is a schematic view of the arrangement of an apparatus for producing pure water according to a fourth embodiment of the present invention; and

FIG. 5 is a view schematically illustrating the temporal change in the concentration of urea in raw water and in treated water.

### DESCRIPTION OF EMBODIMENTS

### First Embodiment

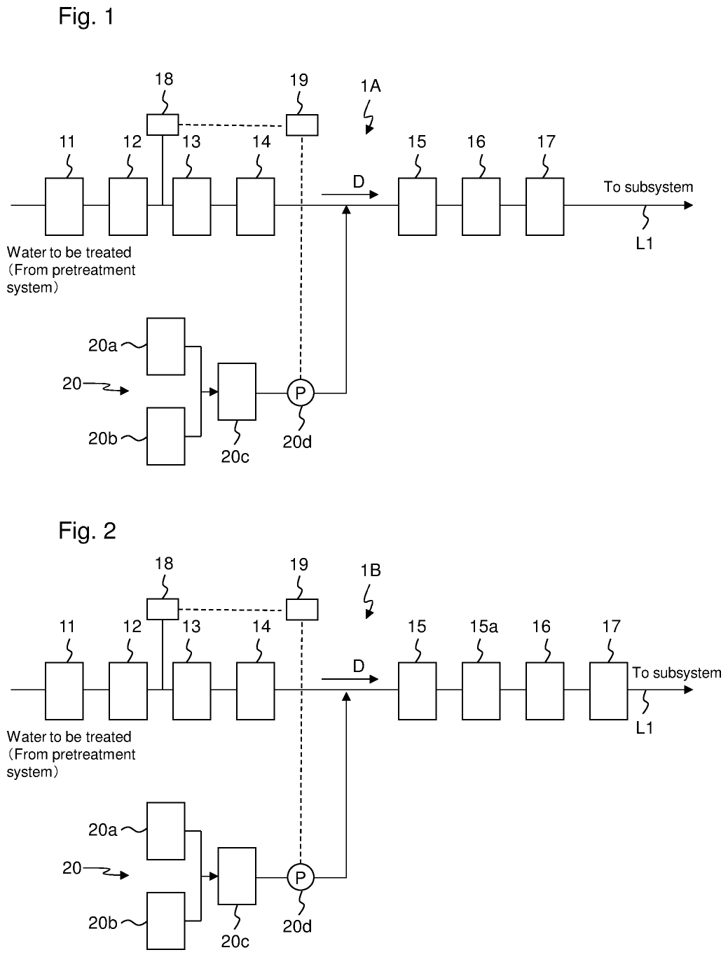

Embodiments of the apparatus for producing pure water and the method for producing pure water of the present invention will be described with reference to the drawings. FIG. 1 schematically illustrates the arrangement of apparatus for producing pure water 1A according to the first embodiment of the present invention. Apparatus for producing pure water 1 (a primary system) constitutes an apparatus for producing ultrapure water together with a pretreatment system upstream thereof and a subsystem (a secondary system) downstream thereof. Raw water (hereinafter, referred to as water to be treated) that is produced by the pretreatment system contains organic materials that include urea.

Apparatus for producing pure water 1A includes filter apparatus 11, bioactivated carbon tower (biological treatment means) 12, first ion exchanger apparatus 13, reverse osmosis membrane apparatus 14, ultraviolet ray radiating apparatus (ultraviolet ray oxidization apparatus) 15, second ion exchanger apparatus 16, and deaeration apparatus 17, and these components are arranged in a series along main line L1 from upstream to downstream in flow direction D of the water to be treated. The water to be treated is pressurized by a raw water pump (not illustrated) and thereafter large particles of dirt and the like having relatively large particle diameters are removed by filter device 11. Impurities such as urea and high-molecular organic materials are removed by bioactivated carbon tower 12. First ion exchanger apparatus 13 includes a cation tower (not illustrated) in which cation exchanger resins are loaded, a decarboxylation tower (not illustrated), and an anion tower (not illustrated) in which anion exchanger resins are loaded, and these towers are arranged in a series from upstream to downstream in the above-mentioned order. Cation components in the water to be treated are removed by the cation tower, carbonic acid in the water to be treated is removed by the decarboxylation tower, and anion components in the water to be treated are removed by the anion tower. Ion components are further removed by reverse osmosis membrane apparatus 14.

Bioactivated carbon tower 12 will now be described in more detail. Carriers that carry microbes are loaded in bioactivated carbon tower 12. Microbes may flow in the tower, but in order to prevent the microbes from flowing out of the tower, it is desirable that the microbes be carried by microbe carrying carriers, especially by fixed-bed carriers that can carry a lot of microbes. Carriers include plastic carriers, sponge carriers, gel carriers, zeolites, ion exchanger resins, activated carbon, and the like, but activated carbon is desirable because of low cost, large specific surface area, and the large number of microbes that can be carried. The water to be treated is supplied to bioactivated carbon tower 12 in a downward flow that can limit the number of microbes that flow out of the tower but may alternatively be supplied in an upward flow. The water to be treated is desirably supplied to bioactivated carbon tower 12 at a velocity of from 4 to 20 hr⁻¹. The water temperature of the water to be treated is desirably from 15 to 35° C., and when the water temperature is not within this range, it is desirable to provide a heat exchanger (not illustrated) upstream of bioactivated carbon tower 12.

The microbes are not limited as long as they include urease, which is an enzyme that decomposes urea. Both autotrophic bacteria and heterotrophic bacteria may be used. Since heterotrophic bacteria require nutrition of organic materials, autotrophic bacteria are more preferable in view of the influence on the water quality. Nitrifying bacteria is a preferable example of the autotrophic bacteria. Urea, which is organic nitrogen, is decomposed into ammonia and carbon dioxide by the breakdown enzyme of nitrifying bacteria (urease), and ammonia is further decomposed into nitrous acid or nitric acid. When heterotrophic bacteria are used, urea is decomposed into ammonia by the breakdown enzyme (urease) in the same manner as nitrifying bacteria, but the ammonia that is generated is used to synthesize bacterial cells in the decomposition process of organic materials. Microbes are available on the market, but, for example, microbes that are contained in sludge (seed sludge) in a sewage treatment plant may also be used.

When a fixed bed is used, the flow path may be clogged by microbes that proliferate in the carriers or between the carriers, and this clogging may interfere with the efficient contact of the microbes with the water to be treated and thus degrade treatment performance. Backwashing is preferably carried out to prevent clogging. Backwash water may be raw water that is supplied to apparatus for producing pure water 1 or treated water (pure water) that is produced by apparatus for producing pure water 1. The backwash water is supplied in the direction opposite to the flow direction of the water to be treated, and microbes that proliferate in the carriers or between the carriers can be removed by the flow of the water, whereby clogging can be prevented. Normally, backwashing is carried out once or twice a week, but when the degree of clogging does not decrease, the backwashing may be carried out more frequently, for example, about once a day.

Urea detecting means 18 that measures the concentration of urea in the water to be treated is provided between bioactivated carbon tower 12 and first ion exchanger apparatus 13. Hypohalogous acid is desirably added in an amount that is positively correlated with (for example, proportional to) the concentration of urea that is measured by urea detecting means 18. By doing so, the amount of hypohalogous acid that is added is limited to an amount necessary and sufficient for treating urea, and excessive addition of hypohalogous acid can be prevented. As a means for measuring urea, there is known a method of measurement based on colorimetry using diacetyl monoxime (for example, see the hygiene test method of The Pharmaceutical Society of Japan). In colorimetry using diacetyl monoxime, other reagents that, for example, promote reaction (for example, an aqueous solution of antipyrine and sulfuric acid, an aqueous solution of semicarbazide hydrochloride, an aqueous solution of manganese chloride and potassium nitrate, an aqueous solution of sodium dihydrogen phosphate and sulfuric acid, and the like) may be used together with the diacetyl monoxime. When antipyrine is used together with diacetyl monoxime, the diacetyl monoxime is dissolved in an acetic acid solution to prepare a solution of diacetyl monoxime and acetic acid. Then, antipyrine (1,5-dimethyl-2-phenyl-3-pyrazolone) is dissolved in, for example, sulfuric acid to prepare a reagent liquid that contains antipyrine. The solution of diacetyl monoxime and acetic acid is then mixed with the sample water, following which the reagent liquid that contains antipyrine is mixed with the sample water. The absorbance at a wavelength of about 460 nm is then measured and compared to a reference liquid in order to obtain a measurement. Alternatively, online measurement equipment (for example, ORUREA (manufactured by Organo Corporation)) may be used. In this case, urea detecting means 18 is desirably connected to control apparatus 19. Control apparatus 19 receives the concentration of urea that is measured by urea detecting means 18 and controls the flow rate of the water that is discharged from transfer pump 20d based on the measurement. In this manner, the amount of hypohalogous acid that is added by means for adding hypohalogous acid 20 is controlled.

Apparatus for producing pure water 1A includes means for adding hypohalogenous acid 20 that adds hypohalogenous acid to the water to be treated. Hypohalogenous acid is hypobromous acid in the present embodiment, but an alternative may be hypochlorous acid or hypoiodous acid. Means for adding hypohalogenous acid 20 includes storage tank 20a for sodium bromide (NaBr) (means for supplying sodium bromide), storage tank 20b for sodium hypochlorite (NaClO) (means for supplying sodium hypochlorite), agitation tank 20c for sodium bromide and sodium hypochlorite (means for mixing sodium bromide and sodium hypochlorite), and transfer pump 20d. Since hypobromous acid is difficult to keep for a long time, hypobromous acid is produced by mixing sodium bromide with sodium hypochlorite at the time when the hypobromous acid is to be used. The hypobromous acid that is produced in agitation tank 20c (the mixing means) is pressurized by transfer pump 20d and is added to the water to be treated that flows in main line L1 at a point between reverse osmosis membrane apparatus 14 and ultraviolet ray radiating apparatus 15. Alternatively, sodium bromide and sodium hypochlorite may be directly supplied to main line L1 such that they are agitated by the flow of the water to be treated in main line L1 to thereby produce hypobromous acid.

Ultraviolet ray radiating apparatus 15 that is positioned downstream of means for adding hypohalogous acid 20 radiates ultraviolet rays to the water to be treated to which hypohalogous acid has been added. Ultraviolet ray radiating apparatus 15 includes a reaction chamber that is made of stainless steel and a tubular ultraviolet ray lamp that is provided in the reaction chamber. Examples of the ultraviolet ray lamp include an ultraviolet ray lamp that generates ultraviolet rays having a wavelength of at least either 254 nm or 185 nm, and a low-pressure ultraviolet ray lamp that generates ultraviolet rays having wavelengths of 254 nm, 194 nm, and 185 nm. The radiation of ultraviolet rays helps hypobromous acid decompose organic materials (urea). Specifically, radiating ultraviolet rays having a wavelength 185 nm or 254 nm to hypohalogous acid generates hypohalogous acid radicals, and these radicals promote the decomposition of persistent organic materials such as urea.

Conventionally, there is known a method of adding hydrogen peroxide to water to be treated in order to remove organic materials. Hydroxyl radicals are generated from hydrogen peroxide by the radiation of ultraviolet rays, and oxidative decomposition of organic materials is promoted by the hydroxyl radicals. However, hypohalogenous acid is much more effective than hydrogen peroxide for removing persistent organic materials such as urea. As a result, it is possible in the present embodiment to reduce the concentration of persistent organic materials such as urea in the ultrapure water that is supplied to points of use.

Second ion exchanger apparatus 16 that is positioned downstream of ultraviolet ray radiating apparatus 15 is a regenerative ion exchanger resin tower in which anion exchanger resins and cation exchanger resins are loaded. Decomposition products of organic materials (carbon dioxide and organic acid) that are generated in the water to be treated by the radiation of ultraviolet rays are removed by second ion exchanger apparatus 16. Thereafter, dissolved oxygen in the water to be treated is removed by deaerator apparatus 17.

The combination of the biological treatment, addition of hypohalogous acid, and radiation of ultraviolet rays provides the following effects. First, the performance of removing urea is improved. Urea can be removed in two stages because urea in the water to be treated is roughly removed by the biological treatment and the remaining urea is then decomposed and removed by the addition of hypohalogous acid and the radiation of ultraviolet rays. Next, variations in the efficiency for removing urea of the biological treatment can be easily dealt with. The activity of the biological treatment is high when the concentration of urea is high, but the activity decreases as the concentration of urea decreases. In addition, it takes several to several tens of days to restore activity that has worsened. Accordingly, if the concentration of urea in the water to be treated increases after the concentration of urea in the water to be treated has decreased and the activity of microbes has also decreased, urea cannot be treated properly, and the efficiency of removing urea also decreases. In this case, the remaining urea can be removed by adding an increased amount of hypohalogous acid on the downstream side in the present embodiment. In other words, means for adding hypohalogous acid 20 and ultraviolet ray radiating apparatus 15 have a backup function for bioactivated carbon tower 12, and even when the activity of microbes in bioactivated carbon tower 12 temporarily decreases, an abrupt increase of the concentration of urea in the treated water can be avoided.

Furthermore, ultraviolet ray lamps, which are very expensive, need to be replaced, for example, once a year due to the drop in the intensity of ultraviolet rays over use. In the present embodiment, urea is roughly removed by the biological treatment in advance. This limits the radiation of ultraviolet rays and thereby prolongs the lifespan and thus decreases the frequency of replacement of the ultraviolet ray lamp. Alternatively, the size of the ultraviolet ray lamp may be reduced. In addition, for the same reason, the amount of hypohalogous acid that is used may also be limited. As a result, the operation cost of apparatus for producing pure water 1A can be reduced.

FIG. 2 schematically illustrates the arrangement of apparatus for producing pure water 1B according to the second embodiment of the present invention. In the present embodiment, additional ultraviolet ray radiating apparatus 15a is arranged in a series with and downstream of ultraviolet ray radiating apparatus 15, that is, between ultraviolet ray radiating apparatus 15 and second ion exchanger apparatus 16. The arrangement is otherwise the same as that of the first embodiment. Downstream ultraviolet ray radiating apparatus 15a removes remaining hypohalogenous acid in the water to be treated through photolysis. Accordingly, load on second ion exchanger apparatus 16 can be reduced and oxidative degradation of the resins of second ion exchanger apparatus 16 can be limited. Additional ultraviolet ray radiating apparatus 15a may be an apparatus identical to ultraviolet ray radiating apparatus 15, and, for example, an ultraviolet ray lamp having a wavelength of at least either 254 nm or 185 nm may be used.

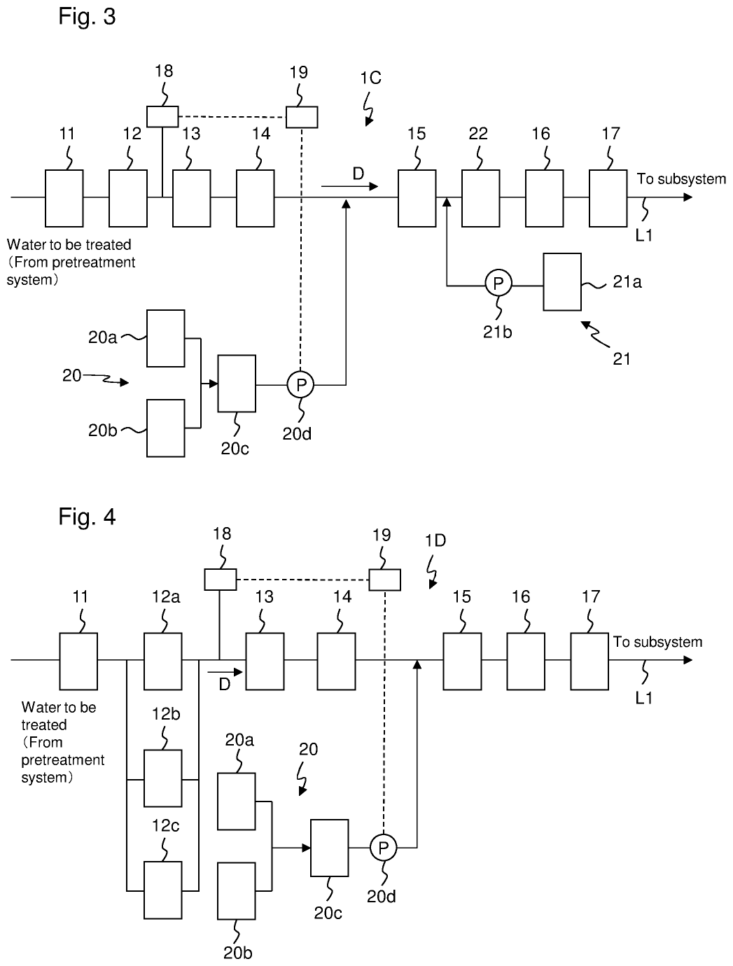

FIG. 3 schematically illustrates the arrangement of apparatus for producing pure water 10 according to the third embodiment of the present invention. In the present embodiment, means for adding reducing agent 21 is provided downstream of ultraviolet ray radiating apparatus 15. In addition, reverse osmosis membrane apparatus 22 is provided downstream of reducing agent adding means 21 and upstream of second ion exchanger apparatus 16. The arrangement is otherwise the same as that of the first embodiment. Means for adding reducing agent 21 removes remaining hypohalogenous acid in the water to be treated. Hydrogen peroxide, sodium sulfite, and the like may be used as the reducing agent. Means for adding reducing agent 21 includes storage tank 21a for the reducing agent and transfer pump 21b. The reducing agent is pressurized by transfer pump 21b and is added to the water to be treated that flows in main line L1 at a position between ultraviolet ray radiating apparatus 15 and reverse osmosis membrane apparatus 22. Reverse osmosis membrane apparatus 22 removes excessive reducing agent. Alternatively, the means for removing the reducing agent may be ion exchanger resins, an electro-deionization apparatus, or the like. Alternatively, these means for removing the reducing agent may be combined in a series.

The means for removing the hypohalogenous acid is not limited to the means of the second and third embodiments and may be any means for removing the hypohalogenous acid (means for removing the oxidizing agent) having the same effect of removing the hypohalogenous acid as additional ultraviolet ray radiating apparatus 15a and means for adding reducing agent 21. For example, a platinum group catalyst such as palladium (Pd), activated carbon, and the like may be used. Alternatively, these means for removing the hypohalogenous acid may be combined in a series.

FIG. 4 schematically illustrates the arrangement of apparatus for producing pure water 1D according to the fourth embodiment of the present invention. In the present embodiment, a plurality of bioactivated carbon towers 12a to 12c are arranged in parallel. The arrangement is otherwise the same as that of the first embodiment. The number of the bioactivated carbon towers is not limited. Bioactivated carbon towers 12a to 12c require regular replacement of activated carbon, and microbes are carried again when the activated carbon is replaced. As will be described in the example, it takes several tens of days until microbes are activated and urea can be efficiently removed. The overall removal rate of urea of bioactivated carbon towers 12a to 12c can be kept at a constant level by sequentially replacing the activated carbon and recarrying of microbes for the plurality of bioactivated carbon towers 12a to 12c. Specifically, even if one of the bioactivated carbon towers has a low urea removal rate, the other bioactivated carbon towers maintain a high urea removal rate, and the concentration of urea in the treated water can thereby be kept at a constant level. Alternatively, a bioactivated carbon tower may be disconnected from apparatus for producing pure water 1D in order to replace activated carbon and recarry the microbes, and the bioactivated carbon tower may then be connected to apparatus for producing pure water 1D when the removal rate of urea reaches a predetermined level. In both methods, apparatus for producing pure water 1D can be continuously operated.

### EXAMPLES

A reagent of urea and a small amount of elements necessary for the biological treatment were added to pure water in order to prepare simulated raw water having a concentration of urea of 100 μg/L. Granular activated carbon (ORBEADS QHG (manufactured by Organo Corporation)) having a bulk volume of 1.0 L was then loaded into a cylindrical column having a volume of 1.5 L in order to prepare a biological treatment tank of the fixed-bed type. Nitrification denitrification sludge was added to the biological treatment tank at a rate of 200 mg/L and was immersed in the raw water. Thereafter, the raw water was continuously supplied to the biological treatment tank in a downward flow for 96 days at SV 12 hr⁻¹ (the flow rate of the supplied water divided by the amount of loaded activated carbon). Throughout the test, the water temperature of the raw water was kept in a range from 18 to 20° C., and the pH was kept in a range from 7.3 to 7.5. Backwashing was carried out for 10 minutes for each backwashing once every three days. Specifically, the treated water was supplied in an upward flow at a linear velocity of LV 25 m/h (the flow rate of the supplied water divided by the cross section of the cylindrical column). The concentration of urea was measured by ORUREA (manufactured by Organo Corporation).

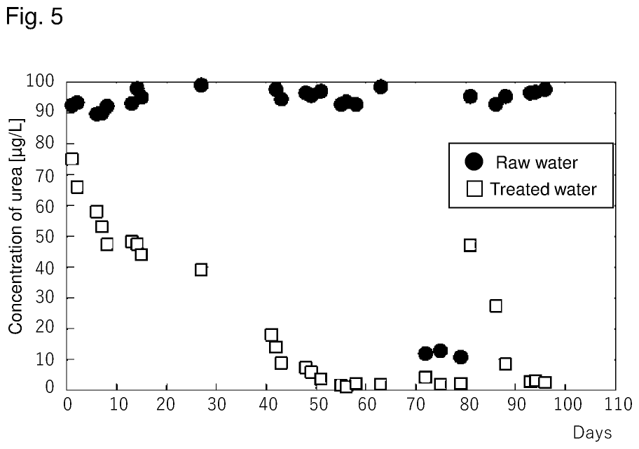

FIG. 5 shows the temporal change of the concentration of urea in the raw water and in the treated water. In order to evaluate the activity of the biological treatment when change occurs in the concentration of urea in the raw water, the concentration of urea in the raw water was set to 100 μg/L until the 63^{rd} day, then lowered to 10 μg/L between the 64th day and the 79th day, and then returned to 100 μg/L on and after the 80th day. The concentration of urea in the treated water was only slowly lowered because it took time until the biological treatment became stable. However, the concentration of urea reached about 2 μg/L on the 55th day and was kept at about 2 μg/L thereafter including the period when the concentration of urea in the raw water was lowered to 10 μg/L. On the other hand, when the concentration of urea in the raw water was increased to 100 μg/L again, the concentration of urea in the treated water increased to 47 μg/L on the 81^{st} day. It took 12 days for the treatment performance to recover. Thus, it was found that the biological treatment had a poor response when the concentration of urea in the raw water was increased.

The treated water that was treated by the bioactivated carbon on the 81^{st} day (the concentration of urea 47 was μg/L) was further treated by hypohalogous acid and ultraviolet rays. The treated water that was treated by the bioactivated carbon was filtered by a filter having a pore size of 0.45 μm in order to remove microbes, and the reaction pH was then adjusted to 5.0 by diluted hydrochloric acid. Hypobromous acid was used as the hypohalogous acid. Hypobromous acid was generated by mixing NaBr with NaClO, and the resulting mixture was then added to the water. The concentration of hypobromous acid was measured by a free chlorine reagent and a salt content meter (manufactured by HANNA) after adding glycine to the sample water to convert free chlorine into combined chlorine. The ultraviolet ray lamp that was used had a wavelength of 254 nm. The intensity of the ultraviolet rays was measured by UV RADIOMETER UVR-2, manufactured by TOPCON CORPORATION. The reaction time was 10 minutes.

The concentration of urea in the treated water was measured in four cases: a case in which hypobromous acid was not added to 100 mL of the sample water (Comparative Example 1), a case in which hypobromous acid was added at 3.2 mg/L to 100 mL of the sample water (Example 1), a case in which hypobromous acid was added at added 6.4 mg/L to 100 mL of the sample water (Example 2), and a case in which hypobromous acid was added at 9.6 mg/L to 100 mL of the sample water (Example 3). The same measurement was also carried out for a case in which hypobromous acid was added at 6.4 mg/L, but ultraviolet rays were not radiated (Comparative Example 2). Table 1 shows the concentration of urea in the treated water after the reaction time passed. In Examples 1 to 3, urea could be efficiently treated by adding hypobromous acid and treating with ultraviolet rays. It was found from Examples 1 to 3 that the removal rate of urea was improved by increasing the amount of added hypobromous acid. Thus, the method of determining the amount of hypohalogous acid to be added based on the concentration of the remaining urea in the water to be treated was found to be effective. It was found from comparison of Example 2 and Comparative Example 2 that a considerable amount of urea could be removed without radiating ultraviolet rays but that the efficiency in removing urea was greatly improved by radiating ultraviolet rays.

TABLE 1

| | | | Concentration | Removing |
|---|---|---|---|---|
| | Hypobromous | | of urea in | rate of |
| | acid added | UV | treated water | urea |
| | (mg/L) | ratiated? | (μg/L) | (%) |
| Example 1 | 3.2 | YES | 17 | 64 |
| Example 2 | 6.4 | YES | 2.4 | 95 |
| Example 3 | 9.6 | YES | 2.1 | 96 |
| Comp. | 0 | YES | 45 | 4 |
| Example 1 | | | | |
| Comp. | 6.4 | NO | 14 | 70 |
| Example 2 | | | | |

Although certain preferred embodiments of the present invention have been shown and described in detail, it should be understood that various changes and modifications may be made without departing from the spirit or scope of the appended claims.

### LIST OF REFERENCE NUMERALS

1A to 1C apparatus for producing pure water
12, 12a to 12c bioactivated carbon tower (biological treatment means)
15 ultraviolet ray radiating apparatus
16 ion exchanger apparatus
18 urea detecting means
20 means for adding hypohalogous acid
21 means for adding reducing agent

1. An apparatus for producing pure water comprising:
a biological treatment means for biological treatment of water to be treated that contains an organic material;
means for adding hypohalogous acid that is positioned downstream of the biological treatment means and that adds hypohalogous acid to the water to be treated after the biological treatment is carried out; and
an ultraviolet ray radiating apparatus that is positioned downstream of the means for adding hypohalogous acid and that radiates ultraviolet rays to the water to be treated to which the hypohalogous acid has been added.

2. The apparatus for producing pure water according to claim 1, wherein the biological treatment means includes bioactivated carbon in which microbes are carried.

3. The apparatus for producing pure water according to claim 1, wherein the biological treatment means includes a plurality of activated carbon towers, wherein bioactivated carbon in which microbes are carried is loaded in each activated carbon tower, and the plurality of activated carbon towers are arranged in parallel.

4. The apparatus for producing pure water according to claim 1, wherein the hypohalogous acid is hypobromous acid.

5. The apparatus for producing pure water according to claim 1, wherein the organic material contains urea,
further comprising urea detecting means that is positioned between the biological treatment means and the means for adding hypohalogous acid and that measures concentration of urea in the water to be treated, wherein
an amount of hypohalogous acid that is added by the means for adding hypohalogous acid is positively correlated with the concentration of urea that is measured by the urea detecting means.

6. The apparatus for producing pure water according to claim 1, further comprising an additional ultraviolet ray radiating apparatus that is positioned downstream of the ultraviolet ray radiating apparatus.

7. The apparatus for producing pure water according to claim 1, further comprising means for removing hypohalogous acid that is positioned downstream of the ultraviolet ray radiating apparatus.

8. A method for producing pure water comprising:
carrying out biological treatment of water to be treated that contains an organic material in order to remove a part of the organic material;
adding hypohalogous acid to the water to be treated after the biological treatment is carried out; and
radiating ultraviolet rays to the water to be treated to which the hypohalogous acid has been added.

9. The method for producing pure water according to claim 8, wherein the water to be treated contains urea.
